(19) United States
(12) Patent Application Publication
(10) Pub. No.: US 2020/0271328 A1
(43) Pub. Date: Aug. 27, 2020

(54) Wall Mounted Radiant Heater

(71) Applicant: HALL LABS LLC, Provo, UT (US)

(72) Inventors: David R. Hall, Provo, UT (US); Arjun Krishna, Orem, UT (US); Jeremy Johnson, Salem, UT (US); Austin Slade, Lindon, UT (US); Dustin Doty, Provo, UT (US)

(73) Assignee: HALL LABS LLC, Provo, UT (US)

(21) Appl. No.: 16/285,433

(22) Filed: Feb. 26, 2019

(51) Int. Cl. F24D 13/02; F24D 19/00; F24D 19/10; F24D 19/02; H05B 3/03; H05B 3/14; H05B 3/28

(52) U.S. Cl. CPC F24D 13/02; F24D 19/008; F24D 19/1096; F24D 19/0203; H05B 3/03; H05B 2203/032; H05B 3/286; F24D 2200/08; F24D 2220/2036; F24D 2220/2054; F24D 2220/2081; H05B 3/146

(57) ABSTRACT

A radiant heater is disclosed. The radiant heater includes a heating layer, with a first elongated conductor configured to receive electricity and a second elongated conductor disposed parallel to the first conductor. A continuous sheet of resistive material adapted to produce heat in response to electrical current is disposed between the first and second elongated conductor. The heater also includes a transparent layer and a non-transparent functional layer that is disposed between the heating layer and the transparent layer. In a preferred aspect, the invention is in the form of a heating mirror.

### TECHNICAL FIELD

The present invention relates to radiant heating devices.

### BACKGROUND

Various solutions exist for heating spaces. Heat can be provided to a complete building (central heat), such as a residence, by a furnace that heats air, e.g. by combustion of a gas, which heated air is blown through vents into the buildings room (forced air). Alternatively, a boiler can heat water, oil or other fluids that circulate through pipes or “radiators” to heat rooms with radiant heat.

Some situations call for “space heaters,” namely heaters that are designed for providing heat to a single space within a building. Space heaters can also used forced air, i.e. heating air and blowing it into the room, or radiant heat, i.e. heating a fluid a radiator or using heating elements that radiate heat into the room.

Naturally, safety is a critical concern for any space heater, especially since most space heaters sit on the floor, where they might be touched by a child or a pet, or even worse, where they might be knocked over and come into contact with something flammable.

### SUMMARY

In a first aspect, the invention is a radiant heater including a heating layer. The heating layer includes a first elongated conductor configured to receive electricity and a second elongated conductor disposed parallel to the first conductor. A continuous sheet of resistive material adapted to produce heat in response to electrical current is disposed between the first and second elongated conductor. The heater also includes a transparent layer and a non-transparent functional layer that is disposed between the heating layer and the transparent layer.

In a preferred aspect, the invention is in the form of a heating mirror. The heating mirror includes a heating layer with an elongated conductor configured to receive electricity, a second elongated conductor disposed parallel to the first conductor, and a continuous sheet of resistive material disposed between the first and second elongated conductor and adapted to produce heat in response to electrical current. The heating mirror also includes a transparent layer, preferably glass. A reflective layer, preferably a silvered coating on the transparent layer, disposed between the heating layer and the transparent layer.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a perspective view of a wall mounted radiant heater in the form of a mirror.

FIG. 2 is an exploded view of the heater of FIG. 1.

FIG. 3A is a top view of the heating core of the heater of FIG. 1.

FIG. 3B is a cross-sectional view of the heating core of FIG. 3.

FIG. 4 is a front view of the preferred heating mirror of the present invention.

FIG. 5 is an illustration depicting the heating mirror in a residential setting, with symbolic.

FIG. 6 depicts the invention in the form of a graphic artwork.

FIG. 7 depicts the invention in the form of a marker board.

FIG. 8A depicts a smart phone running an app to control a plurality of radiant heaters.

FIG. 8B depicts the smart phone of FIG. 8A, displaying a different screen of the app.

FIG. 8C depicts the smart phone of FIG. 8A, displaying a different screen of the app.

FIG. 8D depicts the smart phone of FIG. 8A, displaying a different screen of the app.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein and unless indicated otherwise, the term “current” and “electrical current” is meant to refer to electrical current, whether conducted as alternating current (AC) or direct current (DC).

As used herein, the term “transparent” is used to refer to materials that allow light to pass through so that objects behind can be distinctly seen.

As used herein, the term “functional” as in “functional layer” is used to refer to various functions, including, for example, reflection of light, decoration and providing a backdrop for a marker board.

As used herein, the term “silvered” as in, for example, a “silvered layer” or “silvered backing,” is used to refer to a backing of a silver-colored or other reflective material in order to make a transparent layer reflective.

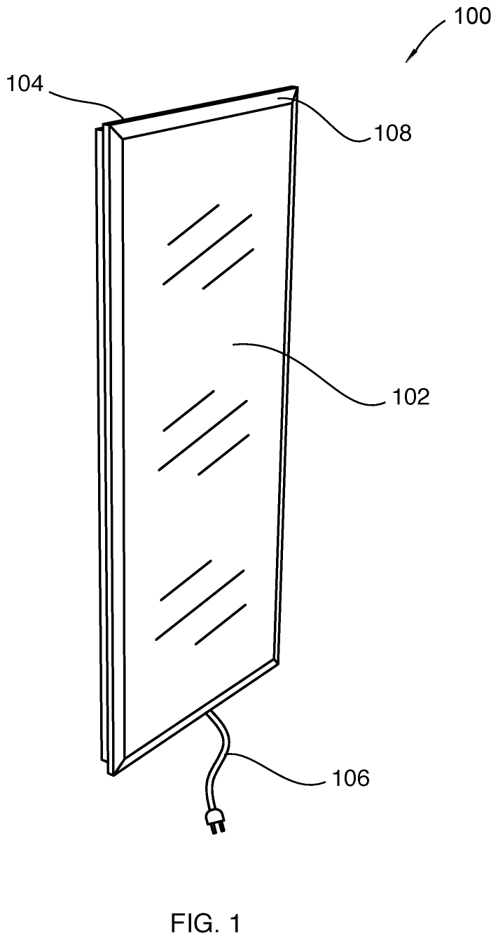

Referring to FIG. 1, the depicted embodiment of the invention is a heater 100 in the form of a mirror 102 adapted to hang on a wall. The mirror includes a sheet of glass 104 and a conventionally silvered backing. In the most preferred embodiment, the mirror includes beveled edges 108. In some embodiments, the mirror includes a frame surrounding the glass. Nevertheless, beveled or rounded edges should make the frame unnecessary. In the depicted embodiment, the heater 100 includes a plug 106 for inserting into a conventional outlet. In the most preferred embodiment, the mirror is designed with a cavity in the back of the mirror so that the cord and plug are hidden behind the mirror in use. In alternative embodiments, the heater is hard-wired, i.e. connected directly to the building's electrical system.

The preferred shape and dimensions of the heater depends on various factors. Naturally, aesthetics are important to consider. While rectangular shapes are generally preferred, in some situations, a round, oval or other shape may be desirable. The dimensions should be selected so as to be aesthetically pleasing as well as functional. Shipping considerations should also be taken into account.

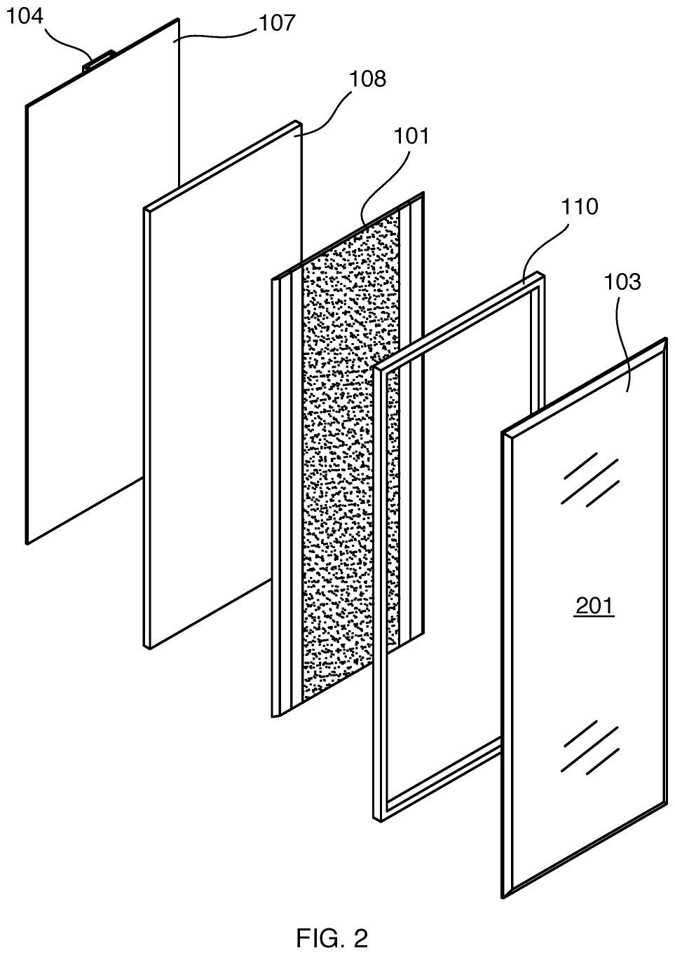

Referring to FIG. 2, the depicted embodiment of the invention includes at least three layers, namely a heating layer 101, a transparent layer 103 and a functional layer. These layers can be joined in any manner. Preferably, they are joined by a conventional adhesive.

The preferred embodiment also includes a backing layer, which should have thermal insulating properties. Preferably, the backing layer comprises a backing sheet 107 and a sheet of insulating material 108. This can be an important feature in preventing the heater from heating up the wall it is attached to and to direct heat forward. Most preferably, the sheet of insulating material 108 includes a metallic foil film that helps reflect radiant heat forward.

Preferably, the heater also includes a frame 110 for holding the heating layer 101, the sheet of insulating material 108 and the backing sheet 107 together. Most preferably, this frame 110 is made from an extruded aluminum alloy.

The backing layer 107 should also have a wall mounting element, such as a hook or bracket 104 for mounting the heater on a wall. Alternatively, the mounting element can employ an adhesive, such as a peel-and-stick pressure-sensitive adhesive pad or pads.

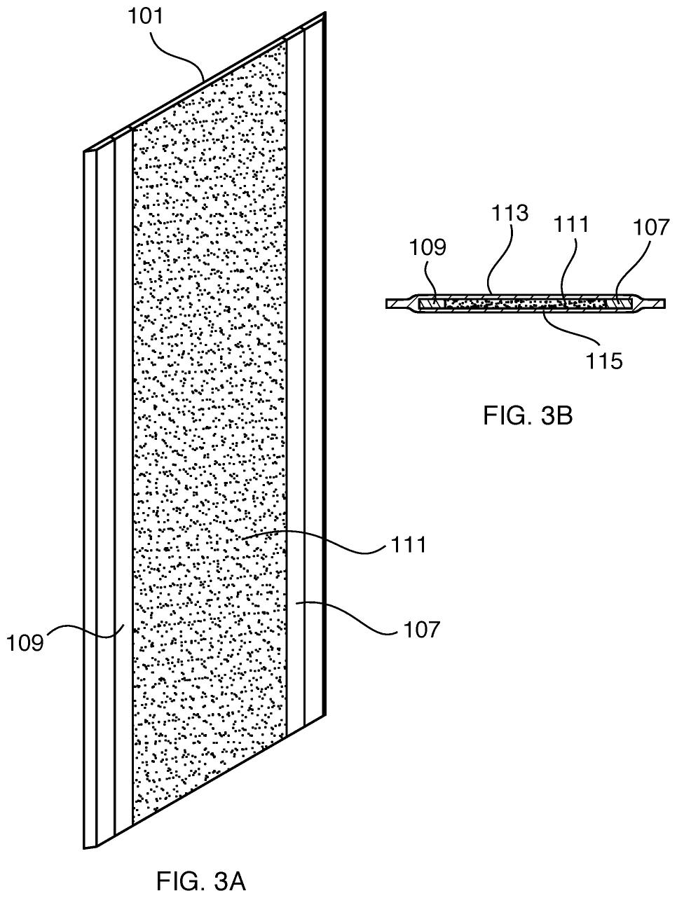

Referring to FIGS. 3A and 3B, the heating layer 101 includes a first elongated conductor 107 and a second elongated conductor 109. Preferably, these elongated conductors are identical and in the form of a metallic ribbon. The metal in the ribbon can be selected from any suitably conductive metal or metal alloy, such as copper, copper alloys, aluminum alloys and the like. Most preferably, the conductors are form from a conventional copper alloy. The dimensions for the elongated conductors are selected in view of the overall dimensions of the heater and the desired heat output. Preferably, the elongated conductors are between 9 and 12 mm wide and between 350 and 500 μm thick. Most preferably, the elongated conductors are about 10 mm wide and about 450 μm thick

Referring again to FIGS. 3A and 3B, between the elongated conductors 107 and 109 is a continuous sheet of resistive material adapted to produce heat in response to electrical current 111. Such sheets can be referred to as electrothermal materials or coatings. In general, these materials comprise some type of conductive particles dispersed within a polymer matrix. While metal particles can be used, the expense and large coefficient of thermal expansion make these less favored. Preferably, the particles are carbon. More preferably, the carbon is in the form of nanoparticles. Most preferably, the carbon nanoparticles and the polymer matrix are those described in U.S. Published Patent Application No. 2016/0185983. In fact, the present inventors purchased sheets of resistive material under the trademark Nanoxene® from the inventors named in U.S. Published Patent Application No. 2016/0185983 and their company, Life-E, located in Sandy Utah.

As shown in FIG. 3, the preferred construction is to have the two elongated conductors 107 and 109 and the continuous sheet 111 laminated between two layers of a transparent polymer film 113 and 115. In this way, the conductors 107 and 109 and the continuous sheet 111 can be inserted into the heater as a unit. Naturally, the polymer film is chosen so as to withstand the heat the sheet 111 will generate.

The properties and dimensions of the elongated conductors and the sheet of resistive material are selected so as to produce the desired range of heat produced by the heater and the surface temperatures desired for the heater. Preferably, the resistive sheet is between 5 and 35 centimeters across, i.e. between the conductors, more preferably between 30 and 35 centimeters, and most preferably 34 centimeters. At this most preferred width, the Nanoxene® material produces about 150 watts per meter. Thus, with the most preferred height of the mirror being about 1.115 meters, the wattage of the heater is about 170 watts.

Naturally, safety is the most important factor in designing any heater. The heater of the present invention is designed so that the surfaces never exceed safe temperatures, i.e. 70° C. Preferably, the surfaces of the heater never exceed 68° C., more preferably 65° C. and most preferably 60° C. These maximum temperatures are preferably set at the factory. In the depicted embodiment, 100, which uses the Nanoxene® film, the maximum temperature on the front of the mirror should be about 65° C.

In the simplest embodiment, the heater is merely switched on by the user when heat is needed and switched off by the user when it is not. Alternatively, the heater includes a settable thermostat, whereby the user sets the desired temperature to which the heater heats its environment. Alternatively, the thermostat can be used to enter a desired maximum temperature and/or a desired minimum temperature. Feedback for the thermostat may come from on onboard thermal sensor or transducer. Alternatively, the feedback may come from a remote device.

Again, in the simplest embodiment, the heater is designed to either be on or off, whether put in that state by the user or a controller. In alternative embodiments, the heater includes potentiometer or other analog or digital device for varying the amount of power delivered to the heating layer, and thus changing the amount of heat generated. In this way, the heater can be programmed for a quicker heating ramp or a slower one.

In the embodiment shown in FIGS. 1-7, the preferred transparent layer 103 is a sheet of glass 201. Alternative embodiments use other transparent material, such as transparent polymers, including poly (methyl methacrylate), acrylic, polycarbonate and polypropylene.

When the heater is designed as a mirror, as shown in FIGS. 1-5, the functional layer is a reflective layer. Preferably, this reflective layer is applied as a coating on the back of the transparent layer. This can be referred to as a silvered backing or coating. The most preferred material for silvering is aluminum, although silver, gold, tin and other shiny metals and alloys may be used. Alternatively, a sheet of reflective material may be used as the functional layer.

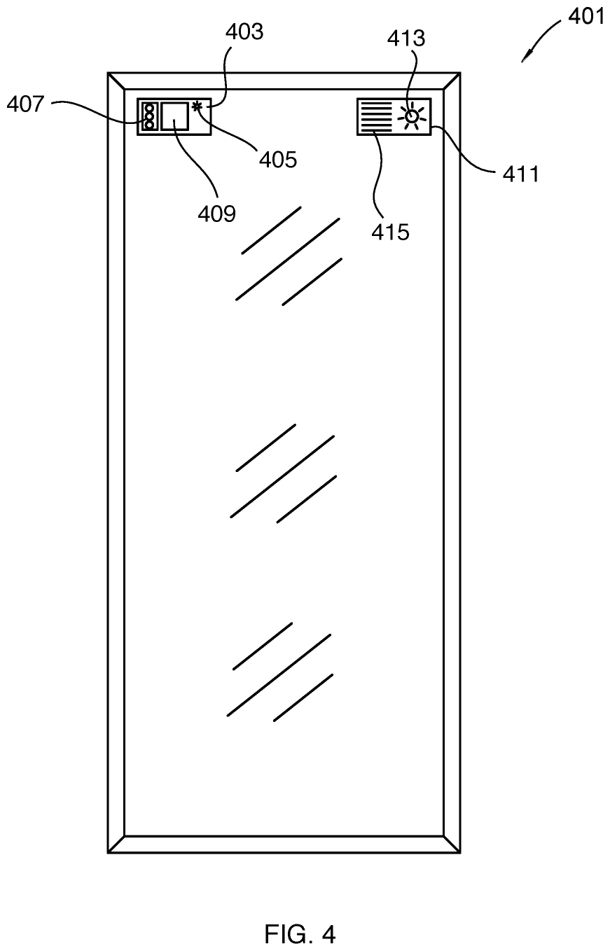

Referring to FIG. 4, the preferred heating mirror 401 includes a visual indicator in the form of a display 403. This display includes an indicator, preferably a light 405, that tells the user that the heater is on. Alternatively, the same light or an additional late can indicate that the surface of the mirror is hot. The display also includes buttons 407, preferably a touch sensitive part of the display, for turning the heater off and on and for selecting the preferred heating level, such as the desired ambient temperature. The depicted display 403 also includes a readout display 409, wherein information about the state of the heater is displayed. For example, the readout may show the temperature of the surface of the mirror and/or the ambient temperature of the air around the mirror.

FIG. 4 also shows that the preferred mirror 401, includes a second display 411. Preferably, this second display is connected to an information source, so as to provide information (415) about things such as the weather (such as through an icon 413), headlines, calendar items, and/or task lists. Preferably, the information source is the user's smart phone. Alternatively, the information source may be provided by a direct connection to the internet. While the heater control display 503 and the information display 505 are shown as separate displays, they may be combined into a single display in alternative embodiments.

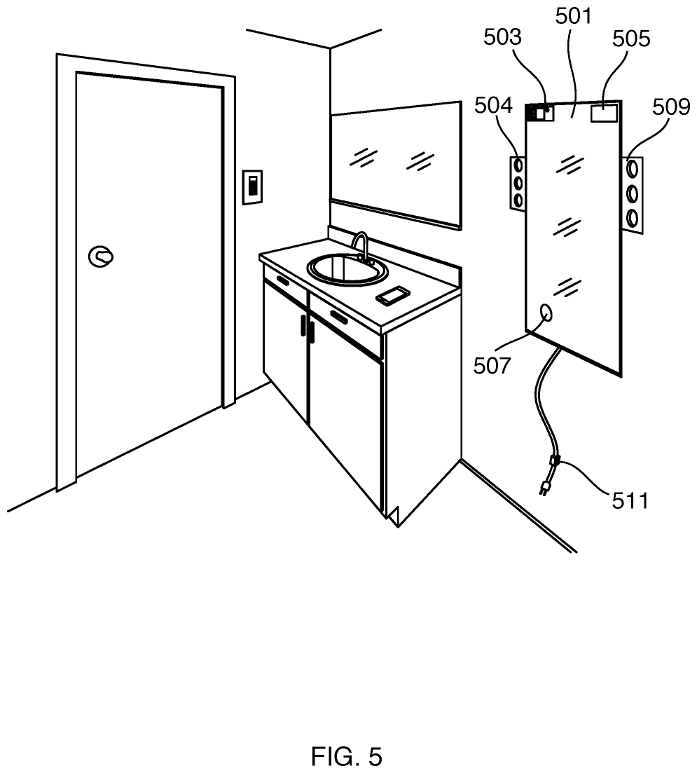

FIG. 5 illustrates the preferred heating mirror 501 hung on the wall in a bathroom. This is a particularly preferred environment of the heating mirror. For one thing, users typically like the bathroom to be heated a bit higher than the rest of the home, especially in the morning and because users generally get wet. For another, a heating mirror can prevent fogging, that is condensation of moisture on the mirror, during activities such as showering.

As shown, the mirror 501 includes the heater control display 503 and the information display 505. The heating mirror 501 in the bathroom preferably includes lights 509 for illuminating the bathroom, and particularly for illuminating the user in front of the mirror. Preferably, the lights 509 are controlled through the heater control display 503. Most preferably, the lights 509 are dimmable.

The mirror 501 also preferably includes at least one sensor 507. This sensor or sensors can be used to detect when a person walks into the bathroom. In response, the heating mirror may be programmed to automatically turn itself on and start heating the bathroom. The heating mirror may also be programmed so that the lights 509 turn on in response to someone entering the bathroom.

The sensor or sensors 507 may also be used to detect the forming of or potential for forming of moisture droplets on the mirror (fogging). In response, the heater may be activated to prevent or ameliorate fogging.

The sensor or sensors (507) may also be used to detect temperature. Preferably, the sensor detects the temperature of the air in front of the mirror. Most preferably, this is accomplished by an infrared sensor. As such, this temperature data can be used by the mirror to determine if the heater should be on or off, or the level of heat produced by the heater, so as to maintain the temperature of the bathroom at the level set by the user. Alternatively, the sensor detects the temperature of the mirror and extrapolates to the temperature of the air in the bathroom.

The mirror 501 also preferably includes a switch 511 for interrupting current to the mirror, to thereby cut power to the mirror.

In some embodiments, the heater is activated by a motion sensor, to detect someone entering the room. In other embodiments, the heater is turned on and off with the lights in that room. For, as someone turns on the lights as he enters the bathroom, he is also turning on the heating mirror. As he turns off the lights and leaves, he is also turning off the heating mirror. In yet other embodiments, the heater is designed to turn off after a certain period of time from being turned on, or after a certain period of time after the motions sensors detect motion.

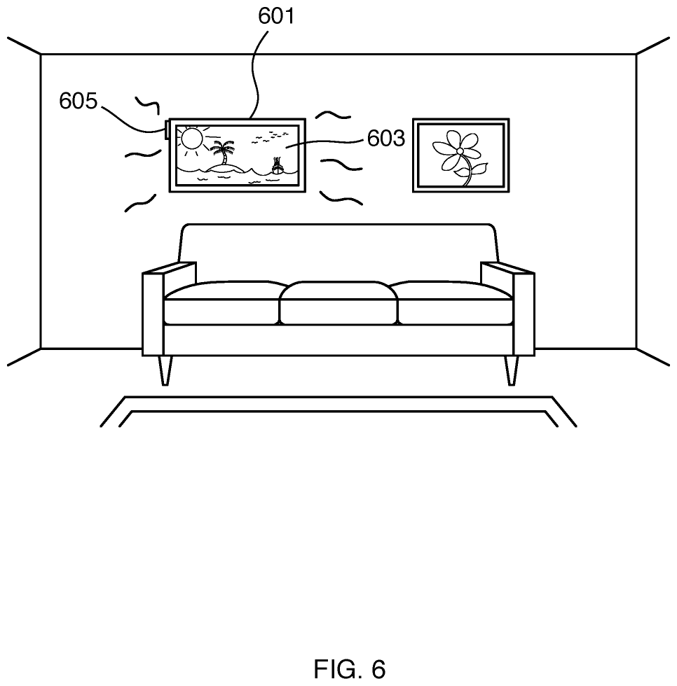

FIG. 6 illustrates an embodiment of the invention wherein the heater 601 is in the form a decorative layer. In particular, the functional layer in this embodiment is a piece of graphic art 603 behind the transparent layer. The decorative layer may take any form, whether representation or abstract. It may even be a single color. The requirement is that the decorative layer is of a suitable material to withstand the heat generated by the heating layer. As such, durable prints on durable materials, such as polymer films, are preferred.

So as not to distract from the decorative purpose of the decorative heater 601, the controls 605 are preferably located discreetly on the side of the heater. Alternatively, the decorative heater 601 is controlled wirelessly and no controls are visible on the heater.

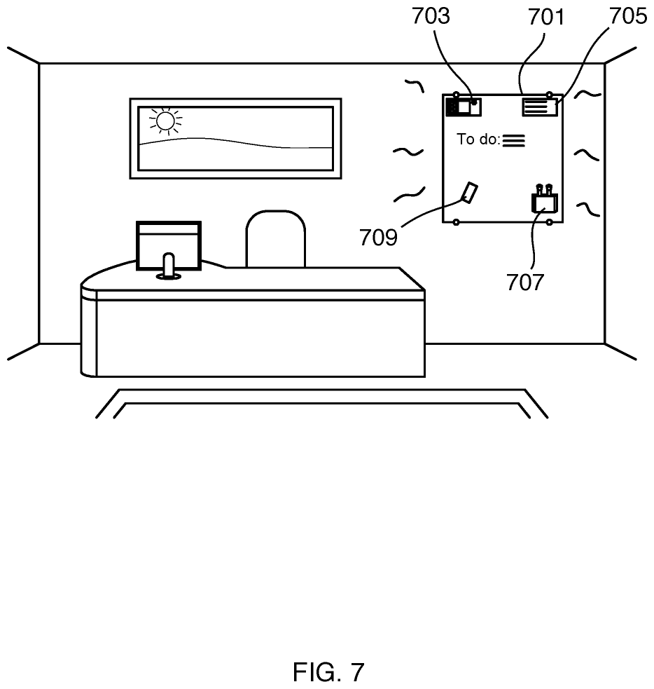

FIG. 7 illustrates an embodiment of the invention wherein the heater 701 is in the form of a marker board, that is, adapted for nonpermanent marking. In this embodiment, the transparent layer is preferably glass adapted to be written on with the typical dry-erase markers 707 and adapted to be cleared with the typical dry-erase eraser 709. The functional layer is opaque, preferably white. Preferably, this is accomplished by coating the back of the transparent layer, preferably glass, with a high temperature tolerant coating, such as high temperature paint. Most preferably, this is white paint.

The functional layer may be printed with lines, if, for example, the board is designed for calendaring or making lists. So long as it does not interfere with the heating function, the functional layer may also include a metallic element, such as a sheet of steel, so as to make it possible to stick items on the markerboard with magnets. The marker board heater 701 preferably includes the control display 703 and the information display 705, although these may be combined in one or eliminated in alternative embodiments.

Preferably, the heaters of the present invention can be controlled wirelessly. More preferably, the heaters of the present invention can be controlled as elements in an “Internet of Things” fashion as part of a “smart home” and programmed with devices, such as those using IFTTT programming. To accomplish this, the heaters of the invention preferably include a controller with a programming module configured to execute instructions, at least for turning the heater on and off. Other instructions could be to set the amount of power delivered to the heating layer. Also, to fit the heater for loT and smart home operation, the heater preferably includes a wireless communication device, communicating with the controller, whereby a user can turn the heater on and off and enter programming instructions.

Preferably, the user communicates with the controller by means of a smart phone running an app. Through that app, the user also receives feedback information about the state of the heater. Most preferably, the app is adapted to control and receive feedback from multiple heaters.

In alternative embodiments, the mirror is supplied with a dedicated remote control device. Preferably, that remote control device can be mounted on the wall of the room. When a dedicated remote control device is used, it is preferable to incorporate a temperature sensor, so that I can give feedback to the heater as to the temperature within the room.

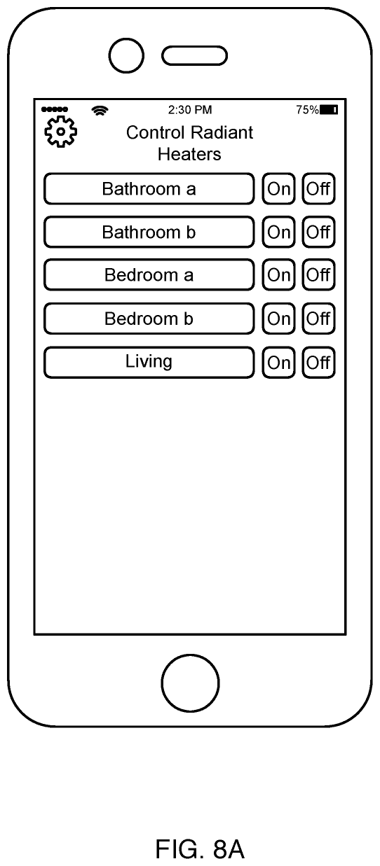

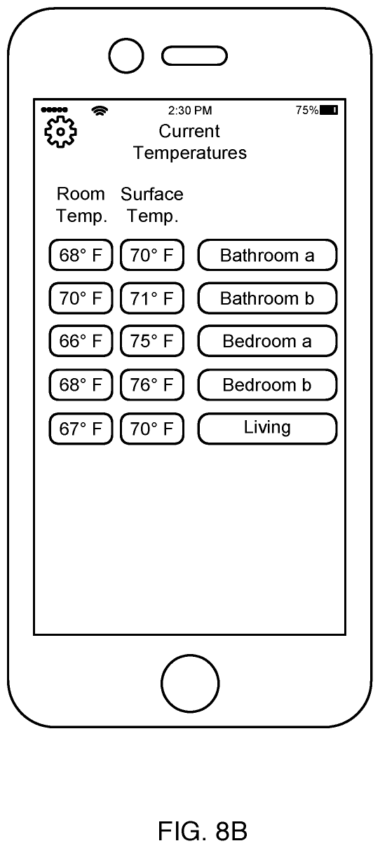

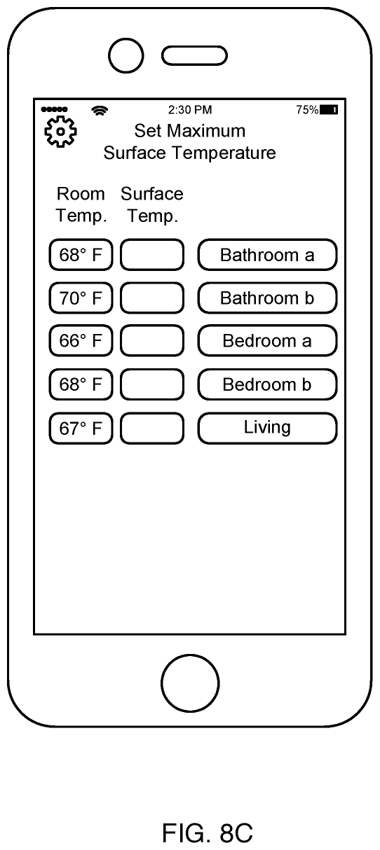

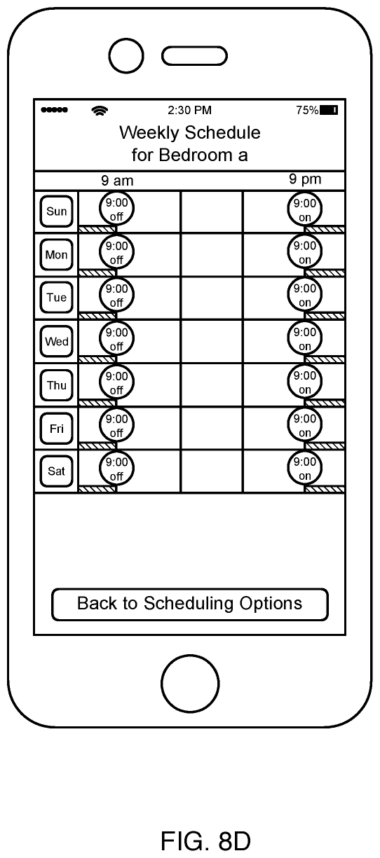

FIGS. 8A-8D depict screenshots of a smart phone running such an app. The screenshot in FIG. 8A shows the app providing the user with the option of turning multiple heaters on or off. As shown, each of the heaters is named and the app would show, by a change in color or some other means, whether each of those heaters is either on or off.

FIG. 8B depicts a screenshot of the app displaying the current temperatures in the rooms and on the surfaces of each of the heaters. These room temperatures can be obtained from sensors mounted to the heaters and configured to distinguish between the surface temperature and the ambient air temperature. Alternatively, the room temperatures can be obtained from separate sensors, for example, mounted on other loT devices in those rooms. By showing both the room temperatures and the surface temperatures, the user is able to determine what temperature to set the surface at to achieve the desired room temperature. Alternatively, the app or controller in the heaters uses the comparison to do the same thing.

FIG. 8C depicts another screenshot of the app which shows the ability of the user to set the maximum surface temperature of each heater in the system. This is a preferred option because it would allow the user to select room by room the maximum surface temperature, so that, for example, the heater in a child's room could be set to a lower maximum temperature. It would also allow a heater in a large room, such as the living room, to be set at a higher maximum temperature, since that heater is heating a larger space.

FIG. 8D depicts yet another screenshot of the app which illustrates the scheduling options for each of the heaters in the system. As can be seen, the user is able to set a weekly schedule of when that particular heater is turned on and off. In this way, the user is able to set, for example, the bathroom heater to come on early enough so the bathroom is warm when he or she enters in the morning. Other living spaces can be heated during expected times of occupancy. For example, the heater can be turned on in the morning so as to warm up spaces before people arise, turned off if everyone is away at work during the day, turned on again before people return from work and then turned off again for the night time. The energy savings and added comfort of such programming are tangible.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A wall mounted radiant heater comprising:
a heating layer comprising:
a first elongated conductor configured to pass electric current;
a second elongated conductor configured to pass electric current and spaced apart from and parallel to the first elongated conductor; and
a continuous sheet of resistive material disposed between the first and second elongated conductor and adapted to produce heat in response to electrical current;
a transparent layer;
a non-transparent functional layer that is disposed between the heating layer and the transparent layer; and
a wall mounting element.

2. The invention of claim 1, wherein the functional layer is a reflective surface.

3. The invention of claim 1, wherein the functional layer is decorative.

4. The invention of claim 1, wherein the functional layer is opaque, and the transparent layer is intended for nonpermanent marking.

5. The invention of claim 1, wherein the continuous sheet of resistive material comprises carbon nanoparticles in a polymer matrix.

6. The invention of claim 5, wherein the first and second elongated conductors each comprise a metal ribbon.

7. The invention of claim 1, further comprising a plug for inserting into a conventional 110V outlet, a first conductive wire communicating with a hot side of the plug and with the first elongated conductor, and a second conductive wire communicating with a neutral side of the plug and with the second elongated conductor.

8. The invention of claim 7, further comprising a switch for interrupting current in the first or second conductive wire.

9. The invention of claim 1, further comprising a potentiometer for adjusting voltage delivered to the first elongated conductor to thereby adjust the amount of heat generated by the heater.

10. The invention of claim 1, further comprising a settable thermostat, whereby a user can set a desired temperature.

11. The invention of claim 10, wherein the thermostat is factory set with a maximum temperature to prevent the heater from reaching unsafe high temperatures.

12. The invention of claim 1, wherein the heater comprises a visual indicator for indicating to the user one or more of the following conditions: the heater is on, the heater is off, the heater is warm, the heater is at a preset temperature, and the heater is hot.

13. The invention of claim 12, wherein the visual indicator is in the form of a lighted display visible through the transparent layer.

14. The invention of claim 13, wherein the lighted display is connected to a wireless network and configured to display one or more of the following: exterior temperature, weather conditions, news headlines, calendar events, and task lists.

15. The invention of claim 1, further comprising a controller with a programming module configured to receive and execute instructions for turning the heater on and off.

16. The invention of claim 15, further comprising a wireless communication device communicating with the controller, whereby a user can turn the heater on and off and enter programming instructions.

17. The invention of claim 15, wherein the user communicates with the controller by a smart phone running an app and receives feedback information about the state of the heater through the app.

18. The invention of claim 1, further comprising a backing layer providing thermal insulation.

19. A heating mirror comprising:
a heating layer comprising:
an elongated conductor configured to receive electricity,
a second elongated conductor disposed parallel to the first conductor, and
a continuous sheet of resistive material adapted to produce heat in response to electrical current disposed between the first and second elongated conductor,
a transparent layer, and
a reflective layer disposed between the heating layer and the transparent layer.

20. The invention of claim 19, further comprising a light for illuminating a user of the mirror.
